(19) United States
(12) Patent Application Publication
(10) Pub. No.: US 2007/0251646 A1
(43) Pub. Date: Nov. 1, 2007

(54) Device for Applying Adhesive Tape

(76) Inventors: Takayoshi Fujino, Kanagawa (JP); Masayuki Kubota, Kanagawa (JP)

Correspondence Address: 3M INNOVATIVE PROPERTIES COMPANY, PO BOX 33427, ST. PAUL, MN, 55133-3427, US

(21) Appl. No.: 10/551,063

(22) PCT Filed: Mar. 24, 2004
(86) PCT No.: PCT/US04/09014

§ 371 Date: Mar. 8, 2007

(30) Foreign Application Priority Data
Apr. 14, 2003 (JP) 2003-109322

(51) Int. Cl. B65C 9/36

(52) U.S. Cl. 156/566

(57) ABSTRACT

An adhesive tape application device 10 for adhering an adhesive tape onto an objective surface area having various profiles. The adhesive tape application device (10) includes a holding mechanism (12) for holding the adhesive tape T of a profile coinciding with that of the objective surface area with the adhesive surface T1 directing outward, and a pressing mechanism (14) for press-bonding the adhesive tape onto the objective surface area. The holding mechanism (12) includes a suction member (18) with an elastic holding surface (16) to be brought into contact with a back surface T2 of the adhesive tape, a base member (20) for holding the suction member to be movable in the pressing direction transverse to the holding surface, and a vacuum source (22) connected to the suction member and generating the negative pressure adjacent to the holding surface to hold the adhesive tape by suction on the holding surface. The pressing mechanism has a drive section (24) for subjecting the suction member to the parallel movement in the pressing direction &agr; relative to the base so that the adhesive surface of the adhesive tape held on the holding surface by suction is pressed onto the objective surface area.

### FIELD OF THE INVENTION

The present invention relates to a device for applying an adhesive tape, particularly to the adhesive tape application device shaped in advance to coincide with a profile of a surface area to which the adhesive tape is adhered.

### BACKGROUND

When an adhesive tape shaped in advance to coincide with a profile of a surface area to which the adhesive tape is adhered, it is necessary to promptly adhere the adhesive tape in a state wherein the latter is accurately located to the objective surface area while avoiding the involvement of air in creases of the adhesive tape or an adhesive surface. To facilitate such an adhering operation, in the prior art, a jig for holding the adhesive tape at a predetermined position relative to the objective surface area is proposed (for example, see Japanese Unexamined Patent Publication (Kokai) No. 2001-39365) or an adhering device of a hand-held type wherein the adhesive tape is gradually adhered to the objective surface area while avoiding the involvement of air in creases of the adhesive tape or an adhesive surface (for example, see Japanese Unexamined Patent Publication (Kokai) No. 2001-115117).

The jig disclosed in the Japanese Unexamined Patent Publication (Kokai) No. 2001-39365 is used for adhering a shaped adhesive tape on a predetermined objective surface area on a doorframe of an automobile (that is, a window frame) in place of painting the same, and includes a jig body having an engagement section to engagingly hold a longitudinal end of the adhesive tape, a nipper for attaching the jig body to a portion of the doorframe, and a position-adjustment means for locating the jig body to a proper position relative to the objective surface area of the doorframe. According to this jig, the adhesive tape is held in a suspended manner by the jig body attached to the doorframe to hang down in front of the objective surface area, and while maintaining this state, the position of the jig body is adjusted so that the profile of the adhesive tape correctly coincides with that of the objective surface area. The adhesive tape correctly positioned to the objective surface area in this manner can be promptly adhered to the objective surface area by a manual operation using a squeegee.

The adhesive tape application device disclosed in Japanese Unexamined Patent Publication (Kokai) No. 2001-115117 is used for adhering a shaped adhesive tape on a predetermined objective surface area on a doorframe of an automobile (a window frame) in place of painting the same, and includes a base member for holding the adhesive tape so that the adhesive surface thereof is exposed, an elastic roller held by a rotary shaft on the base member for pressing the adhesive tape onto the objective surface area, and means for locating the base member at a proper position relative to the objective surface area and then attaching the same to the doorframe. According to this application device, the adhesive tape is introduced into a tape introduction path within the base member and placed on the elastic roller while exposing the adhesive surface thereof, after which the base member is attached to a proper position on the doorframe so that the adhesive tape is nipped between the elastic roller and the objective surface area at a suitable pressure. In this state, the base member is manually moved along the doorframe to promptly adhere the adhesive tape onto the objective surface area while correctly positioning the tape to the latter.

In the prior art device for applying an adhesive tape, disclosed in Japanese Unexamined Patent Publication (Kokai) No. 2001-39365, since the operation is carried out by using the squeegee while holding the adhesive tape by the jig body in a suspended manner to be hung down in front of the objective surface area, it is difficult to apply this to the operation for adhering the adhesive tape to a long surface extending in the direction different from that of the gravity (for example, a surface of a slanted part of the doorframe). Also, since the adhering operation itself is carried out exclusively manually by using a squeegee, there might be the variety in the finally adhered adhesive tape in accordance with a skill of the operator.

On the other hand, the prior art device for applying an adhesive tape disclosed in Japanese Unexamined Patent Publication (Kokai) No. 2001-115117 can press the adhesive tape onto the objective surface area by the action of the elastic roller only by moving the base member along the doorframe. Since this device, however, gradually adheres the adhesive tape from one end thereof in the longitudinal direction, there may be a risk in that the adhering position of the adhesive tape relative to the objective surface area is increasingly shifted due to a slight error in the attachment position of the base member to the objective surface area. Also, when the objective surface area has a complicated profile, it is necessary to divide the profile into several sections, to which are sequentially adhered a plurality of adhesive tapes having simple profiles. Such an operation is troublesome and causes the variety of shapes of the adhered adhesive tapes particularly in the boundary between adjacent sections.

### SUMMARY

An object of the present invention is to provide a device for applying an adhesive tape (e.g., a pressure sensitive adhesive backed paint replacement film) having a profile coinciding with that of an objective surface area to the latter, which is capable of promptly and accurately adhering the adhesive tape without needing the skill of the operator while avoiding the variety of the finished adhesive tape adhered to the objective surface area.

In one aspect of the present invention, a device is provided for applying an adhesive tape, comprising a holding mechanism for holding an adhesive tape having an adhesive surface and a back surface opposite to the adhesive surface in a state where the adhesive surface faces outward, the adhesive tape being provided with a profile coinciding with a profile of an objective surface area to which the adhesive tape is adhered, and a pressing mechanism for pressing the adhesive tape held by the holding mechanism onto the objective surface area; wherein the holding mechanism includes a suction member provided with an elastic holding surface capable of making contact with the back surface of the adhesive tape, a base member supporting the suction member shiftably in parallel displacement in a pressing direction transverse to the holding surface, and a vacuum source connected to the suction member and capable of generating a negative pressure adjacent to the holding surface to make the holding surface suck and hold the adhesive tape; and wherein the pressing mechanism includes a drive section for shifting the suction member in parallel displacement in the pressing direction relative to the base member, to press the adhesive surface of the adhesive tape held by suction on the holding surface onto the objective surface area.

The above-mentioned device for applying an adhesive tape can be made to operate to automatically adhere the adhesive tape to the entirety of the objective surface area substantially at the same time by driving the drive section while holding the adhesive tape by suction on the holding surface of the suction member. The holding surface can be made to elastically deform in conformity with the profile of the objective surface area when the adhesive surface of the adhesive tape is pressed onto the objective surface area.

In the device of the present invention, the suction member can include an elastic wall provided with the holding surface and a through-hole opening in the holding surface, a negative pressure chamber formed adjacent to the elastic wall at a side opposite to the holding surface, communicated with the holding surface via the through-hole and connected to the vacuum source, and an elastic column supporting the elastic wall. The elastic column can be made to support the elastic wall when the negative pressure is generated in the negative pressure chamber by the operation of the vacuum source, and elastically deforms when the pressure is applied to the holding surface from outside.

The negative pressure chamber can include a plurality of negative pressure regions formed separately from each other, individually communicated with the holding surface and individually connected to the vacuum source, each of the negative pressure regions being provided with the elastic column. It is possible to avoid the malfunction of one negative pressure region to spread over the entirety of the holding surface by making the individual negative pressure regions independent from each other.

The suction member can includes a plurality of suction blocks formed separately from each other, respectively having the negative pressure regions and being combined with each other, the suction blocks being respectively provided with holding surface regions cooperating with each other to define the holding surface. It is possible to easily manufacture the suction members having the holding surfaces of various profiles.

The plurality of suction blocks can be supported on the base member of the holding mechanism in a cooperative arrangement in which the holding surface regions are adjacent to each other and capable of making contact almost entirely with the back surface of the adhesive tape, and the drive section of the pressing mechanism can be made to shift the plurality of suction blocks synchronously in the pressing direction transverse to each of the holding surface regions relative to the base member. It is possible to accurately adhere the adhesive tape held by suction on the plurality of suction blocks on the objective surface area.

The holding mechanism can further include an intermediate support member for fixedly supporting the plurality of suction blocks and shiftably held on the base member, and the pressing mechanism can further include a guide member for guiding the intermediate support member in the pressing direction on the base member during an operation of the drive section. It is possible to accurately translate the plurality of suction blocks in the pressing direction when the tape is pressed.

The vacuum source can include a plurality of vacuum generators independent from each other, individually connected to the plurality of negative pressure regions. It is possible to improve the negative pressure generating function of the plurality of negative pressure regions.

The holding surface of the suction member can be constituted as a flat surface or a curved surface, substantially free of twist and step as a whole. It is possible to effectively exclude the involvement of air in the creases of the adhesive tape.

The present inventive device can further comprise a positioning mechanism for positioning the holding mechanism at a predetermined adhering-preparation position in the objective surface area. The positioning mechanism can be made to include a first engagement member fixedly held on the base member, a second engagement member movably held on the base member, and a drive element for moving the second engagement member relative to the base member. The first and second engagement members can be fixedly engaged with an article having the objective surface area, under a driving operation of the drive element, to locate the suction member to the adhering-preparation position. It is possible to adhere the adhesive tape at an accurate position on the objective surface area.

### BRIEF DESCRIPTION OF THE DRAWINGS

FIG. 1A conceptual illustration of a main part of one embodiment of the adhesive tape application device according to the present invention.

FIG. 2 An illustration of an adhesive tape and an objective surface area to which the adhesive tape application device shown in FIG. 1.

FIG. 3 A plan view of the entirety of the adhesive tape application device of FIG. 1 while partly using a block diagram.

FIG. 4 A plan view of the adhesive tape application device of FIG. 3 as seen from the opposite side.

FIG. 5 A sectional view taken along a line V-V in FIG. 3.

FIG. 6 A plan view of a suction member mounted to the adhesive tape application device of FIG. 3.

FIG. 7 An enlarged plan view of part of the suction member shown in FIG. 6.

FIG. 8 A sectional view taken along a line VIII-VIII of FIG. 7.

FIG. 9 Illustrations showing the steps of the operation of the adhesive tape application device of FIG. 3, wherein (a) is an engaging state of the second engagement member and (b) is an engaging state of the first engagement member.

FIG. 10 A conceptual illustration of the adhering steps of the adhesive tape application device of FIG. 3.

FIG. 11A conceptual illustration of the adhering steps of the adhesive tape application device of FIG. 3, wherein (a) is a state in which the suction member is at the adhering preparation position, and (b) is a state in which the suction member is at the adhering completion position.

FIG. 12 A conceptual illustration of the adhering steps of a modified adhesive tape application device.

FIG. 13 A conceptual illustration of the adhering steps of the adhesive tape application device of FIG. 12, wherein (a) is a state in which the suction member is at the adhering preparation position, and (b) is a state in which the suction member is at the adhering completion position.

### DETAILED DESCRIPTION

The present invention will be described in detail with reference to the attached drawings illustrating the preferred embodiments.

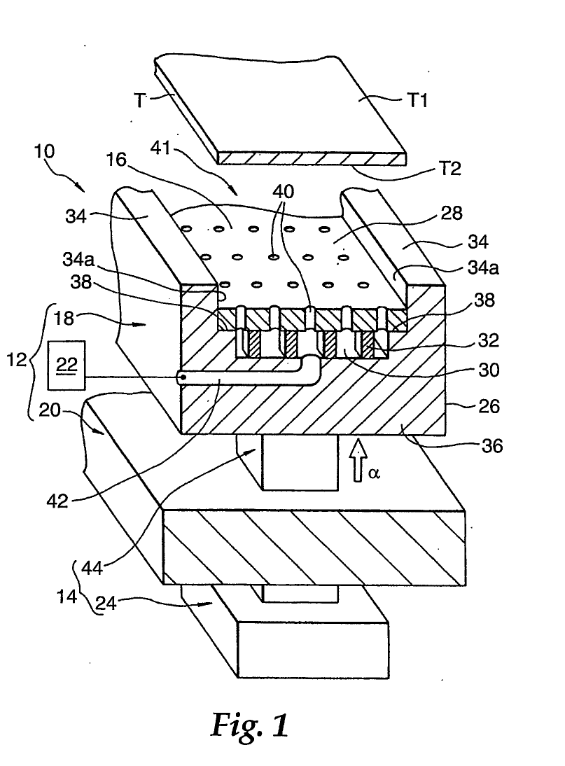

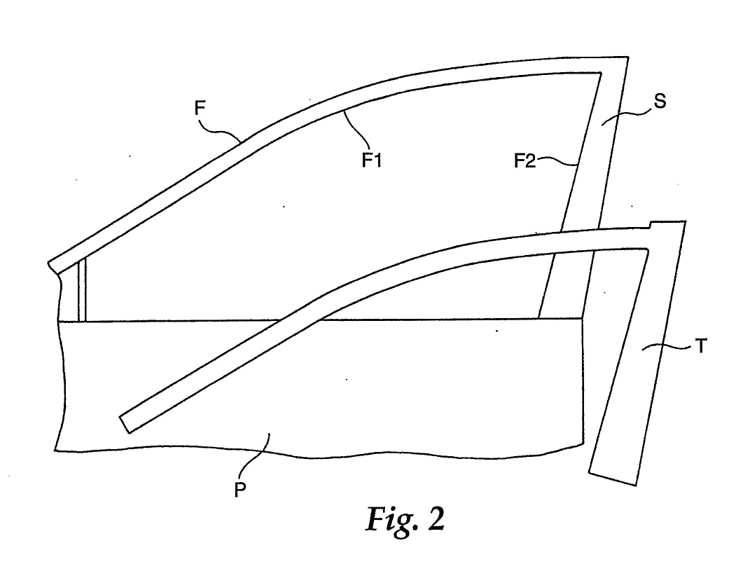

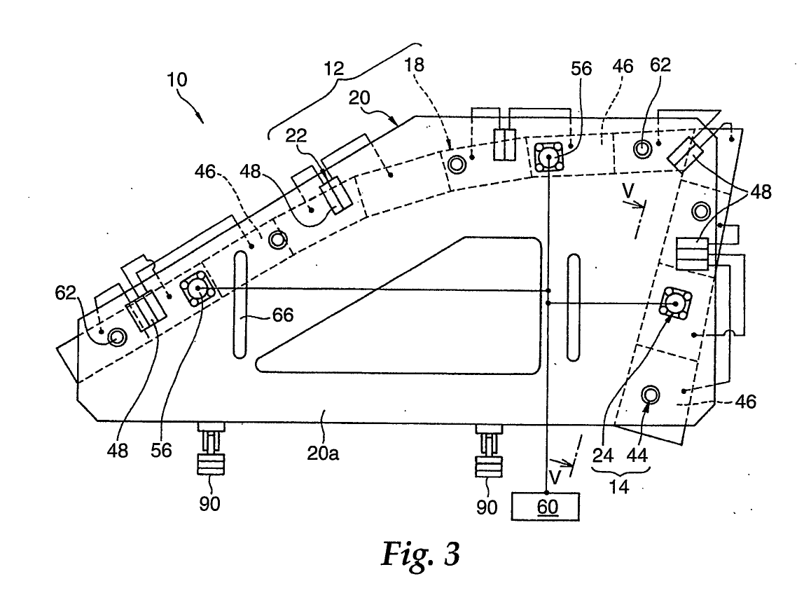

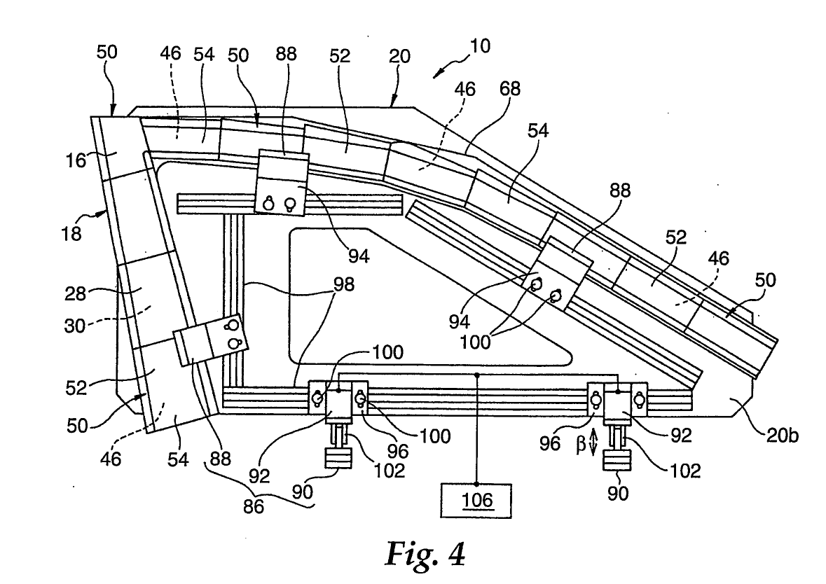

FIG. 1 is a conceptual illustration of a main part of an adhesive tape application device 10, together with an adhesive tape T, according to one embodiment of the present invention; FIG. 2 is an illustration of the adhesive tape T to which the device 10 is applied and a objective surface area S to which the tape is adhered, and FIGS. 3 and 4 are illustrations of the entirety of the device 10 as seen in different directions. The device 10 is used for adhering an adhesive tape to a specified objective surface area, which adhesive tape is shaped in advance to have a profile coinciding with that of to the latter. Concretely, as shown in FIG. 2, the device 10 is adapted to automatically adhere the shaped adhesive tape T to a specified objective surface area S on a doorframe F (that is, a window frame) of an automobile, in place of painting. However, the adhesive tape application device is not intended to be limited to this application.

As shown in FIG. 1, the adhesive tape application device 10 includes a holding mechanism 12 for holding the adhesive tape T having an adhesive surface T1 and a back surface T2 opposite to the adhesive surface T1 while directing the adhesive surface T1 outward, and a pressing mechanism 14 for press-bonding the adhesive tape T held by the holding mechanism 12 onto the objective surface area S. The holding mechanism 12 is provided with a suction member 18 having s holding surface 16 having the elasticity to be in contact with the back surface T2 of the adhesive tape T, a base member 20 for supporting the suction member 18 to be movable parallel to the pressing direction transverse to the holding surface 16, and a vacuum source 22 connected to the suction member 18 to generate the negative pressure adjacent to the holding surface 16 so that the adhesive tape T on the holding surface 16. The pressing mechanism 14 is provided with a drive section 24 for moving the suction member 18 toward the base member 20 parallel to the pressing direction (shown by an arrowα in the drawing) to press the adhesive surface T1 of the adhesive tape T held on the holding surface 16 by suction onto the objective surface area S. The adhesive tape application device 10 of such a structure can automatically and simultaneously adhere the adhesive tape T to the objective surface area S substantially all over the entirety thereof by the action of the drive section 24 while maintaining the adhesive tape T by the suction on the holding surface 16 of the suction member 18.

The suction member 18 of the holding mechanism 12 includes a body 26, an elastic wall 28 having the holding surface 16, a negative pressure chamber 30 formed between the body 26 and the elastic wall 28 and disposed adjacent to the elastic wall 28 on a side opposite to the holding surface 16, and a plurality of elastic columns 32 distributed in the negative pressure chamber 30 on the body 26. The body 26 is formed of a rigid material such as metal, plastic or others, and has a pair of side walls 34 disposed opposite to each other to define the negative pressure chamber 30 and a bottom wall 36 extending between the pair of side walls 35 to be an integral body. Each of relatively opposed surfaces 34a of the side walls 34 is formed as a stepped surface having a step between a lower portion adjacent to the bottom wall 36 and an upper portion away from the bottom wall 36. This stepped portion has a shoulder 38 having an outer edge (which is an intersection of the shoulder 38 with the upper portion of the relatively opposed surface in the side wall 34) defining a profile coinciding with that of the adhesive tape T.

The elastic wall 28 is a flat plate member formed of elastic material such as synthetic rubber or others, and provided with a profile coinciding with a profile of the adhesive tape T as a whole on the holding surface 16 thereof. In the elastic wall 28, a plurality of through-holes 40 are properly distributed, which extend through the elastic wall 28 in the thickness direction thereof and opening in the holding surface 16. The elastic wall 28 is firmly fixed via an adhesive or the like to both the shoulders 38 with substantially no gap relative to the pair of side walls 34 of the body 26 in the vicinity of the opposite side edge areas extending in the longitudinal direction. Thereby, a tape receiving recess 41 is formed between the upper portions of the relatively opposed surfaces 34a of the side walls 34 in the body 26 and the holding surface 16 of the elastic wall 28, for receiving the adhesive tape T while locating the same at a proper position.

The negative pressure chamber 30 communicates with the holding surface 16 via the plurality of through-holes 40 provided in the elastic wall 28 and is connected to the vacuum source 22 via a pipe 42 provided in the body 26. The plurality of elastic columns 32 disposed in the negative pressure chamber 30 are formed of elastic material such as synthetic rubber or others, and interposed between the bottom wall 36 and the elastic wall 30 at positions shifted from the through-holes 40. These elastic columns 32 support the elastic wall 28 so that the original flat plate shape (particularly as seen in the transverse direction) thereof is maintained by preventing the elastic wall 28 from being sucked into the body 26 when the negative pressure generates in the negative pressure chamber 30 by the operation of the vacuum source 22. On the other hand, these elastic columns 32 are elastically deformable in the direction toward the bottom wall 36 together with the elastic wall 28 when the external pressure exceeding a predetermined level is applied to the holding surface 16.

The suction member 18 of the above structure can hold by suction the adhesive tape T in a state sufficiently being stretched all over the holding surface at a proper position on the suction member 18. Also, in this state, when the suction member 18 presses the adhesive surface T1 of the adhesive tape T to the objective surface area S having a bulged and curved cross-section such as an outer surface of the doorframe F of an automobile, the elastic wall 28 is passively elastically deformed to a shape coinciding with the cross-sectional shape of the objective surface area S, whereby it is possible to apply a uniform pressure to substantially the entirety of the adhesive tape T. Further, at this time, the originally flat plate-shaped elastic wall 28 operates to gradually push the adhesive tape T toward the opposite side edges of the objective surface area S after initially pressing the adhesive tape T onto the most bulged central portion of the objective surface area S. Accordingly, the suction member 18 can adhere the adhesive tape T onto the objective surface area S while effectively avoiding the involvement of air in creases thereof and the adhesive surface.

The drive section 24 of the drive mechanism 14 is adapted to linearly reciprocate the suction member 18 in a predetermined direction relative to the base member 20, an example of which is a hydraulic or pneumatic cylinder unit. To ensure a precision of such a reciprocation, the pressing mechanism 14 is advantageously provided with a guide member 44 for guiding the suction member 18 on the base member 20 in the pressing direction α and the opposite thereto when the drive section 24 is operated. Also, to adhere the adhesive tape T while being accurately positioned to the objective surface area S, it is advantageous to further provide a positioning mechanism for locating the holding mechanism 12 to a predetermined adhesion-preparing position in the objective surface area S prior to the commencement of the adhering operation. With reference to FIGS. 3 to 11, a practically advantageous embodiment of the adhesive tape application device 10 will be described below.

As shown in FIGS. 3 and 4, the suction member 18 of the holding mechanism 12 is formed by dividing the negative pressure chamber 30 into a plurality of (twelve in the drawing) independent negative pressure regions 46. These negative pressure regions 46 are respectively communicated with the holding surface 16 of the suction member 18 and connected to the vacuum source 22. In correspondence thereto, the vacuum source 22 consists of a plurality of (twelve in the drawing) independent vacuum generators 48. According to such a structure, even if either of the plurality negative pressure regions 46 forming the negative pressure chamber 30 is not able to generate a desired negative pressure due to the useless invasion of peripheral air or others, the lowering of the function of the negative pressure chamber 30 as a whole for sucking the adhesive tape is minimized for the sake of the negative pressure generating action of the other normal negative pressure regions 46.

More concretely, the suction member 18 is formed by assembling a plurality of independent suction blocks 50 with each other, each having the negative pressure region 46 and arranged at predetermined relative positions. Each of the suction blocks 50 has an elastic wall piece 52 for constituting the elastic wall 28 in cooperation with the other. Each of these elastic wall pieces 52 has a holding surface region 54 which cooperates with the other to form the holding surface 16. The respective elastic wall piece 52 has a plurality of through-holes 40 (FIG. 1) opening in the holding surface region 54. As will be described later, in the respective negative pressure region 46, the above-mentioned elastic columns 32 (FIG. 1) are distributed. Thus, the respective suction block 50 performs the same action as in the above-mentioned suction member 18 to hold the corresponding small portion of the adhesive tape T in the holding surface region 54.

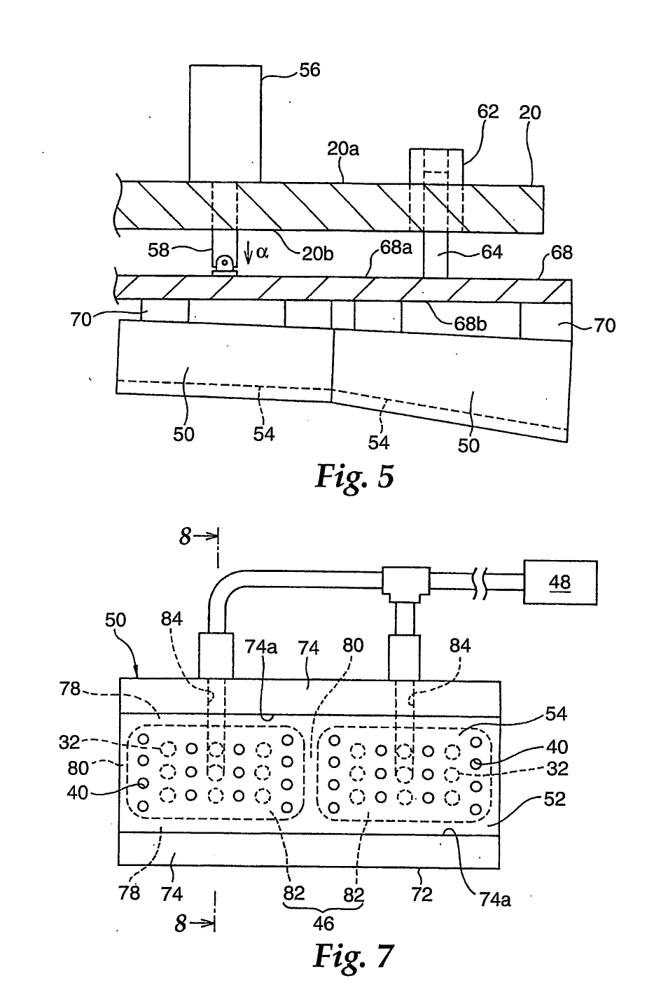

The base member 20 of the holding mechanism 12 is a flat plate member of a trapezoidal shape as seen in a plan view formed of a hard material such as metal. In a first surface 20a thereof, a plurality of vacuum generators 48 forming the vacuum source 22, and a plurality of (three in the drawing) pneumatic cylinder units 56 forming the drive section 24 of the pressing mechanism 14 are properly arranged (see FIG. 3). As shown in FIG. 5, the respective pneumatic cylinder unit 56 projects a piston rod 58 thereof from a second surface 20b opposite to the first surface 20a of the base member 20 and is disposed on the base member 20. These pneumatic cylinder units 56 are connected to a common air compressor 60 via a compressed air supplying path and a switching valve (not shown).

Also, in the base member 20, a plurality of (six in the drawing) linear guides 62 constituting the guide member 44 for the pressing mechanism 14 are properly arranged to balance with the respective pneumatic cylinder units 56. As shown in FIG. 5, the respective linear guide 62 projects a movable element 64 thereof from the second surface 20b of the base member 20 and is placed on the base member 20. A pair of handles 66 for manually operating the adhesive tape application device 10 by the operator are provided at proper positions on the first surface 20a of the base member 20. The above-mentioned vacuum generator 4 and air compressor 60 are connected to an ON-OFF switch (not shown) disposed in the vicinity of the handles 66 via a proper control circuit (not shown) if desired.

On the second surface 20b of the base member 20, an intermediate support member 68 is provided, for fixedly supporting a plurality of suction blocks 50 constituting the suction member 18 at predetermined positions (see FIGS. 4 and 5). The intermediate support member 68 is formed of a hard material such as metal to be a generally L-shaped flat plate member as seen in a plan view, and movably supported on the base member 20 generally in parallel to the base member 20 to be laid on a bottom of the suction member 18 extending generally in an L-shape manner. Each of the plurality of pneumatic cylinder units 56 provided on the base member 20 is coupled by a tip end of the piston rod 58 thereof to the first surface 68a of the intermediate support member 68 in a rockable manner. In the first surface 68a of the intermediate support member 68, a movable element 64 of the respective linear guide 62 provided in the base member 20 is fixedly coupled at a tip end area thereof.

On the other hand, in the second surface 68D of the intermediate support member 68 opposite to the first surface 68a thereof, a plurality of suction blocks 50 are fixed via legs 70 if necessary. These suction blocks 50 have holding surface regions 54 which are adjacent to each other and provided on the second surface 68b of the intermediate support member 68 to be in contact with the entirety of the back surface T2 of the adhesive tape T. The pressing mechanism 14 moves the plurality of suction blocks 50 in synchronism with each other parallel to the base member 20, which suction blocks are fixed in cooperation with each other to the intermediate support member 68, in the pressing direction α and opposite thereto transverse to the respective holding surface regions.

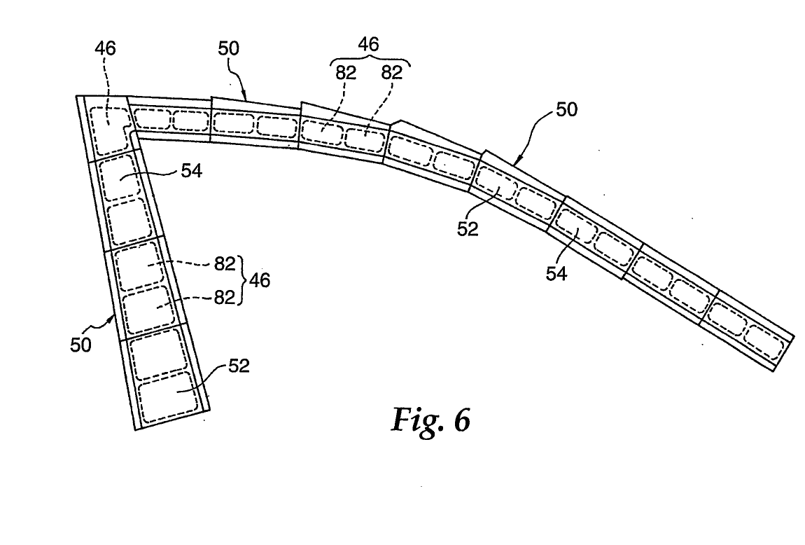

As shown in FIG. 6, the plurality of suction blocks 50 are combined to cooperate with each other so that the holding surface 16 formed by the cooperation of the holding surface regions 54 has a profile coinciding as a whole with that of the adhesive tape T. At this time, the supporting surface 16 is preferably a flat surface or a curved surface with no substantial twist and step. Such a holding surface 16 is relatively easily formed by combining the plurality of suction blocks 50, each having the holding surface region 54 of a flat surface or a curved surface with no twist so that no step generates between adjacent holding surface regions 54. In this case, even if there is a small twist or step in the objective surface area S, it is possible to apply a uniform pressure on the adhesive tape T as a whole by three-dimensionally conforming the holding surface 16 with the objective surface area S.

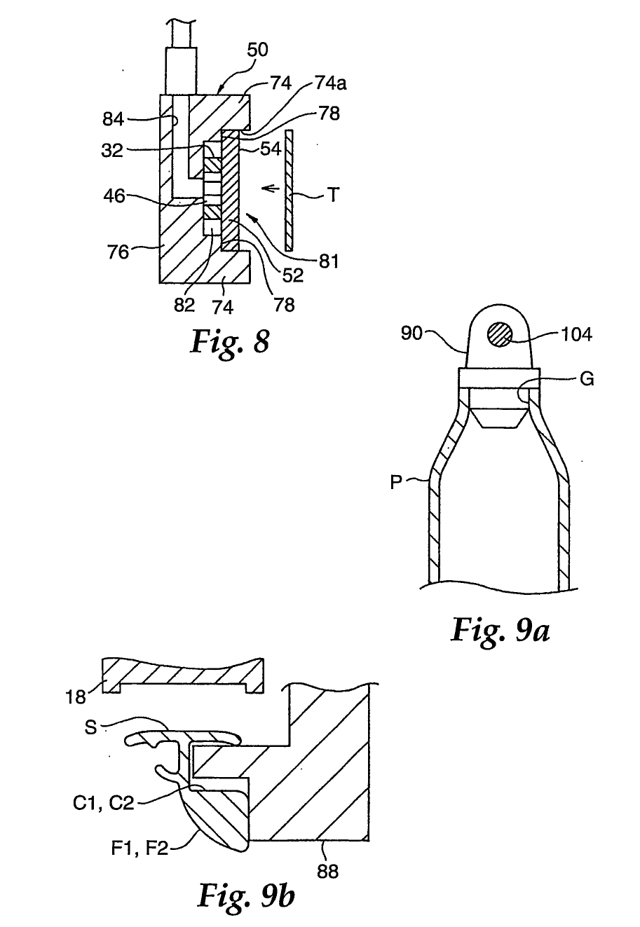

As shown in FIGS. 7 and 8 in an enlarged scale, the respective suction block 50 is provided with a body portion 72 which is a part of the body 26 of the suction member 18, the elastic wall piece 52 attached to the body portion 72 and having the holding surface region 54, the negative pressure region 46 formed between the body portion 72 and the elastic wall piece 52 at a position adjacent to the elastic wall piece 52 opposite to the holding surface region 54, and a plurality of elastic columns 32 distributed in the negative pressure region 46 on the body portion 72. The body portion 72 has a pair of opposed side walls 74 defining the negative pressure region 46, and a bottom wall 76 extending between the side walls 74 to be an integral body. The opposite surfaces 74a of the side walls 74 are formed as stepped surfaces having steps between the lower portion adjacent to the bottom wall 76 and the upper portion away from the bottom wall 76. At this step, a shoulder surface 78 is provided, which exhibits a profile on the outer edge (that is, a crossing line with the upper portion of the opposite surface of the side wall 74) coinciding with that of the adhesive tape T as a whole. Further, at longitudinal opposite ends of both the side walls 74, there is a bulged portion having an integrally communicating shoulder surface 80 with no step on the shoulder surface 78 between the opposite surfaces 74a of the side walls 74.

The elastic wall piece 52 is fixed to the shoulder surfaces 78, 80, for example, by an adhesive or others in the vicinity of the opposite side edges extending in the longitudinal direction so that no gaps are substantially formed relative to the pair of side walls 74 of the body portion 72. Thereby, the negative pressure region 46 is defined between the body portion 72 and the elastic wall piece 52, and a tape-receiving recess 81 is formed, for receiving a part of the adhesive tape T while locating the same to a proper position between the upper portion of the opposite surfaces 74a of both the side walls 74 of the body portion 72 and the holding surface region 54 of the elastic wall piece 52.

In the illustrated embodiment, some (eleven in the drawing) of the plurality of suction blocks 50 have the respective negative pressure region 46, each being further divided into a plurality of (two in the drawing) sub-sections 82 (see FIG. 6). In this suction block 50, the negative pressure region 46 is divided into the sub-sections 82 by extending a bulged portion having the above-mentioned shoulder surface 80 between the opposite surfaces of both the side walls 74 at an intermediate position as seen in the longitudinal direction (see FIG. 7). In this case, the sub-sections 82 communicate with the holding surface region 54 via the plurality of through-holes 40 formed in the elastic wall piece 52, and are connected to the common vacuum generator 48 via pipes 84 individually provided in the body portion 72. By such a structure, it is possible to improve the reliability and stability of the negative pressure generating action in the negative pressure region 46 of the respective suction block 50. In this regard, it is also possible to individually connect the respective sub-section 82 to the vacuum generator 48.

Referring again to FIGS. 3 and 4, the adhesive tape application device 10 further includes a positioning mechanism 86 for locating the holding mechanism 16 to a predetermined adhesion-preparation position relative to the objective surface area S. The positioning mechanism 86 is provided with a first engagement member 88 fixed to the base member 20, a second engagement member 90 movably held by the base member 20, and a drive element 92 for moving the second engagement member 90 relative to the base member 20. The first engagement member 88 has an attachment portion 94 integral therewith, and fixedly engageable with the doorframe F (FIG. 2) having the objective surface area S while being fixed to a desired position of the base member 20 with the attachment portion 94. The second engagement member 90 has a movable attachment portion 96 by which it is fixed to a desired position of the base member 20. In this state, by driving the drive element 92, the second engagement member 90 is engageable with the door panel P (FIG. 2) connected to the doorframe F. In the illustrated embodiment, a plurality of (three in the drawing) first engagement member 88, a plurality of (two in the drawing) second engagement member 90 and a plurality of (two in the drawing) drive elements 92 related to the respective second engagement members 90 are used.

In the second surface 20b of the base member 20, a plurality of (four in the drawing) attachment rails 98 are fixedly provided at a position shifted inward relative to the intermediate support member 68 of a generally L-shape as seen in a plan view for supporting the plurality of suction blocks 60. Three of the first engagement members 88 are individually fixed desired positions in the three attachment rails 98 provided on upper and lateral sides of the second surface 20b of the base in the drawing. The two second engagement members 90 are fixed to desired positions on the single attachment rail 98 provided below the second surface 20b of the base in the drawing by a bolt 100 mounted to the attachment portion 96 in a position-adjustable manner. The first and second engagement members 88, 90 is movable in the longitudinal direction of the related attachment rail 98 while unfastening the bolt 100, and an attachment angle to the related attachment 98 is also changeable. Accordingly, by fixing each of the first and second engagement members 88, 90 at an optimum position adjusted in advance on the corresponding attachment rail 98, it is possible to locate the holding mechanism 12 to a proper adhesion-preparation position described later.

The respective drive element 92 consists of a pneumatic cylinder unit and is mounted to the attachment portion 96 of the related second engagement member 90. Also, A piston rod 102 thereof is connected to the engagement member 90 via a pin 104 (FIG. 9(b)) to be rockable relative to each other. Two drive elements 92 are coupled to the common air compressor 106 via a compressed air supply path and a switch valve, and by the operation of the air compressor 106, the related second engagement member 90 is made to linearly reciprocate in the lateral direction (as shown by an arrow β) to the base member 20. The air compressor 106 is connected to an ON-OFF switch (not shown) provided, for example, in the vicinity of the handle 66 via a suitable control circuit (not shown) if desired, in the same manner an in the above-mentioned vacuum generator 48 of the holding mechanism 12 or the air compressor 60 of the pressing mechanism 14. In this connection, the air compressor 106 of the positioning mechanism 86 and the air compressor 60 of the pressing mechanism 14 may be constituted by the same machine.

The positioning mechanism 86 of the above structure operates to fixedly engage the plurality of first and second engagement members 88, 90 to an article having the objective surface area S (that is, an automobile door having a doorframe F and a door panel P) and to accurately locate the suction member 18 on the base member 20 at the adhesion-preparation position. In this regard, the adhesion-preparation position is determined in advance while taking into account the parallel movement of the suction member 18 due to the operation of the drive section 24

Next, the steps of the tape-adhering operation by the above-mentioned adhesive tape application device 10 will be described below.

Upon the commencement of the tape-adhering operation by the above-mentioned adhesive tape application device 10, the three pneumatic cylinder units 56 constituting the drive section 24 of the pressing mechanism 14 are set to an initial state wherein the piston rods 58 thereof are in a retreated position. Also, the three first engagement members 88 and the two engagement members 90 are fixed in advance at proper positions on the base member 20, as well as the respective engagement member 90 is set to an initial state wherein the piston rod 102 of the related drive element 92 is at a retreated position.

In this initial state, as the preparation operation, the twelve vacuum generators 48 constituting the vacuum source 22 of the holding mechanism 12 are started at a position away from the automobile door with the adhesive tape to generate a uniform negative pressure in the negative pressure regions 46 of the plurality of suction blocks 50 constituting the suction member 18. In this state, the back surface T2 of the adhesive tape T is brought into contact with all of the holding surface 16 of the suction member 18, the opposite side edges of the adhesive tape T are arranged along the opposite side surfaces 34a of the both side walls 34 of the suction member 18 so that the adhesive tape T is sufficiently stretched to be properly held by suction in the tape-receiving recess 41 of the suction member 18. At this time, it is advantageous in the operation to adhere a release paper (not shown) in advance to the adhesive surface T1 of the adhesive tape T, which is then peeled off from the adhesive tape T after the latter is suitably held by the suction member 18.

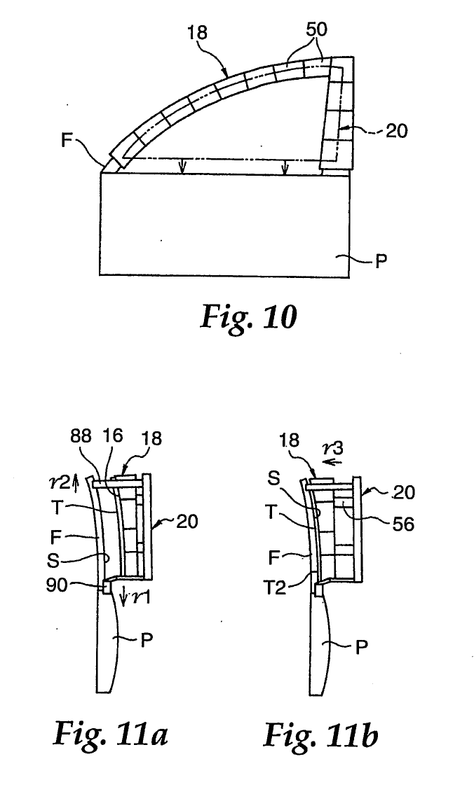

After the preparation operation, the adhesive tape application device 10 approaches the automobile door so that the suction member 18 thereof is opposed to the objective surface area S to fit the plurality of initialized second engagement members 90 into the glass slide groove G of the upper edge in the door panel P (FIG. 9(a)). Then, one of the first engagement members 88 located at a lateral side is fit into a glass receiving groove C1 of the vertical frame F1 in the doorframe F (FIG. 2) and engaged therewith (FIG. 9(b)). Thereby, the base member 20 is in a temporary attachment state in which the base member 20 does not move in the approaching and separating directions. In the temporary attachment state, the air compressor 106 is started to drive the two drive elements 92 in synchronism therewith and to move both the second engagement members 90 in the direction γ1 away from the base member 20 (FIG. 11(a)). Thus, the base member 20 is lifted upward against the gravity in the direction γ2 (FIG. 11(a)) away from the door panel under the sliding engagement between the lateral first engagement member 88 and the vertical frame F1 of the doorframe F, and as a result, the upper two first engagement members 88 are fit into the glass receiving groove C2 of the slanted frame part F2 in the doorframe F (FIG. 2) and engaged therewith (FIG. 9(b)). In this state, by maintaining the operative pressure of the respective drive element 92, the base member 20 fixedly mounted to the automobile door and the suction member 18 of the base member 20 is accurately held and located at the adhesion-preparation position at which the adhesive tape T held by the holding surface 16 is properly opposed to the objective surface area (FIGS. 10 and 11(a)).

At the adhesion-preparation position, the air compressor 60 is started to operate the three pneumatic cylinder units 56 in synchronism with each other to move the suction member 18 supported by the intermediate support member 68 in the direction γ3 (FIG. 11(b)) away from the base member 20. Thereby, the adhesive surface T2 of the adhesive tape T held by suction on the suction member 18 is substantially as a whole and simultaneously brought into contact with the objective surface area S (FIG. 11(b)). By maintaining the operative pressure of the respective pneumatic cylinder unit 56, a uniform pressure is applied to the adhesive tape T as a whole under the elastic deformation of the above-mentioned elastic wall 28 and the elastic column 32 whereby the adhesive tape T is accurately positioned and automatically adhered to substantially all over the objective surface area S. At this time, as described above, since the adhesive tape T is gradually press-bonded within a short time from the bulged central area to the both side edges of the objective surface area S, the air involvement in the creases of the adhesive tape T or the adhesive surface T1 is effectively avoidable.

After the adhesive tape T has been automatically adhered to the objective surface area S, the three pneumatic cylinder units 56 are reversely operated in synchronism with each other to move the suction member 18 in parallel in the direction approaching the base member 20. Thereby, the adhesive tape T is detached from the suction member 18 and left on the objective surface area S. Simultaneously with the contact of the adhesive surface T2 of the adhesive tape T with the objective surface area S, or after a predetermined time period has passed therefrom, the respective vacuum generator 48 is preferably made to stop to cease the vacuum sucking operation of the suction member 18. Whereby, the adhesive tape T can be smoothly detached from the holding surface 16. Then, the two drive elements 92 are reversely operated in synchronism with each other to move both the second engagement member 90 toward the base member 20. As a result, due to the operation of the gravity, the upper two first engagement members 88 are detached from the slanted frame portion F2 of the doorframe. Thus, the one side first engagement member 88 is detached from the vertical frame portion F1 and the two second engagement members 90 are detached from the door panel, whereby the adhesive tape application device 10 is removable from the automobile door.

Finally, as a finishing operation, the incompletely adhered portion of the adhesive tape T is manually amended while expelling the involved air in the adhesive surface T2 by using the squeegee. At this time, by defining the transverse-directional dimension of the adhesive tape T somewhat larger than the transverse-directional dimension of the objective surface area S, it is possible to wrap the opposite side edge areas of the adhesive tape T around the back side of the doorframe F, whereby the edge-peel of the adhesive tape T is avoidable whereby the desired configuration of the finished tape is obtainable.

According to the adhesive tape application device 10, since the drive section 24 is operated while holding the adhesive tape T on the holding surface of the suction member 18 by suction, the adhesive tape T is automatically adhered to the objective surface area S substantially as a whole and simultaneously. Thereby, even if the objective surface area S has a portion extending in the direction different from that of the gravity (the slanted frame portion F2 in the doorframe F), it is possible to easily adhere the adhesive tape T thereto. Since this adhering operation is not relied on the manual operation using the squeegee, the finishing of the adhered adhesive tape is improved without depending to the skill of the operator.

Since the adhesive tape T having in advance a profile substantially the same as that of the objective surface area S extending to have an L-shape is instantaneously adhered to the latter by the action of the drive section 24, it is possible to easily and promptly carry out the adhering operation excellent in reproducibility in comparison with the conventional method in which a plurality of simple-shaped adhesive tapes are assembled to each other. In addition, the inventive method is different from the gradual adhering operation using an elastic roller, and capable of avoiding the positional shift of the adhesive tape T relative to the objective surface area S during the adhering operation, provided the suction member 18 is accurately located to the objective surface area S in advance.

On this point of view, the adhesive tape application device 10 provided with the positioning mechanism 86 is adapted to fixedly mount the base member 20 at a predetermined position relative to the automobile door having the objective surface area S so that the suction member 18 is located to the predetermined adhering preparation position, whereby it is possible to accurately locate the adhesive tape T to the objective surface area S by the parallel movement of the suction member 18 caused by the drive section 24.

Further, by manufacturing the holding surface 16 of the suction member 18 so that the profile of the holding surface 16 coincides with that of the objective surface area to be adhesive, it is possible to adhere the adhesive tape shaped to have various profiles in advance to the objective surface area S other than that shown in the drawing. On this point of view, various holding surfaces 16 can be relatively easily formed by constituting the suction member 18 by combining a plurality of suction blocks 50.

While the present invention has been described based on the preferred embodiments, the adhesive tape application device according to the present invention should not be limited thereto but may be variously modified.

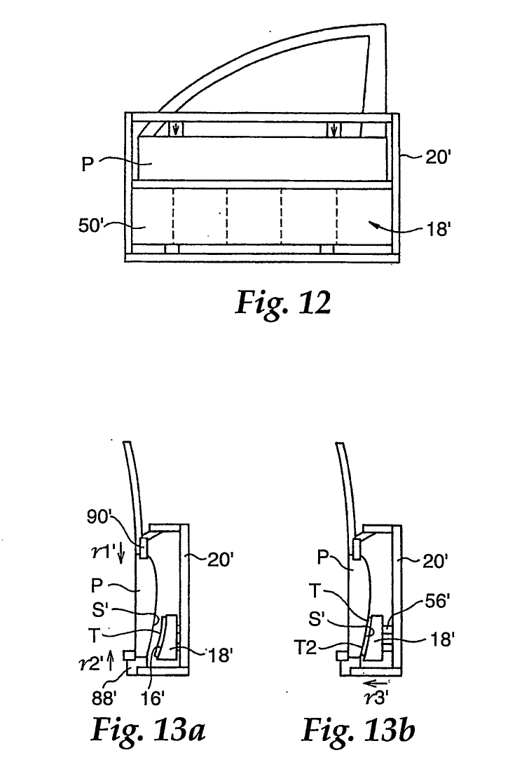

For example, as shown in FIGS. 12 and 13, the adhesive tape application device may be adapted to adhere the adhesive tape to a predetermined position on an outer surface of the door panel P of the automobile door. According to this structure, after the adhesive tape T is properly held on the holding surface 16′ of the suction member 18′ by suction, the second engagement member 90′ is fit into the upper end of the door panel P to temporarily mount the base member 20′, then the base member 20′ of the second engagement member 90′ is moved in the direction γ1′ to be away from the base member 20′ so that the base member 20′ is lifted in the direction γ2′ and the suction member 18′ of the base member 20′ is accurately held at the adhering preparation position (FIGS. 12 and 13(a)). At this adhering preparation position, the pneumatic cylinder unit 56′ is operated to subject the suction member 18′ to the parallel movement in the direction y3′ away from the base member 20′. Whereby a uniform pressure is applied to substantially the entirety of the adhesive tape T held by suction on the suction member 18′ to result in the automatic adhesion in which the adhesive tape T is accurately positioned to the objective surface area S′ (FIG. 13(b)).

As apparent from the above description, according to the present invention, in the adhesive tape application device having a profile coinciding with that of the objective surface area to the latter, it is possible to promptly and accurately adhere the adhesive tape to the objective surface area having various profiles without needing the skill of the operator as well as to avoid the variance of the finished adhesive tape.

1-9. (canceled)

10. A device for applying an adhesive tape, comprising a holding mechanism for holding an adhesive tape having an adhesive surface and a back surface opposite to the adhesive surface in a state where the adhesive surface faces outward, the adhesive tape being provided with a profile coinciding with a profile of an objective surface area to which the adhesive tape is to be adhered, and a pressing mechanism for pressing the adhesive tape held by said holding mechanism onto the objective surface area;
wherein said holding mechanism includes a suction member provided with an elastic holding surface capable of making contact with the back surface of the adhesive tape, a base member supporting said suction member shiftably in parallel displacement in a pressing direction transverse to said holding surface, and a vacuum source connected to said suction member and capable of generating a negative pressure adjacent to said holding surface to make said holding surface suck and hold the adhesive tape; and
wherein said pressing mechanism includes a drive section for shifting said suction member in parallel displacement in said pressing direction relative to said base member, to press said adhesive surface of the adhesive tape held by suction on said holding surface onto the objective surface area.

11. The device for applying an adhesive tape according to claim 10, wherein said suction member includes an elastic wall provided with said holding surface and a through-hole opening in said holding surface, a negative pressure chamber formed adjacent to said elastic wall at a side opposite to said holding surface, communicated with said holding surface via said through-hole and connected to said vacuum source, and an elastic column supporting said elastic wall.

12. The device for applying an adhesive tape according to claim 11, wherein said negative pressure chamber includes a plurality of negative pressure regions formed separately from each other, individually communicated with said holding surface and individually connected to said vacuum source, each of said negative pressure regions being provided with said elastic column.

13. The device for applying an adhesive tape according to claim 12, wherein said suction member includes a plurality of suction blocks formed separately from each other, respectively having said negative pressure regions and being combined with each other, said suction blocks being respectively provided with holding surface regions cooperating with each other to define said holding surface.

14. The device for applying an adhesive tape according to claim 13, wherein said plurality of suction blocks are supported on said base member of said holding mechanism in a cooperative arrangement in which said holding surface regions are adjacent to each other and capable of making contact almost entirely with the back surface of the adhesive tape, and wherein said drive section of said pressing mechanism shifts said plurality of suction blocks synchronously in said pressing direction transverse to each of said holding surface regions relative to said base member.

15. The device for applying an adhesive tape according to claim 13, wherein said holding mechanism further includes an intermediate support member for fixedly supporting said plurality of suction blocks and shiftably held on said ba se member, and wherein said pressing mechanism further includes a guide member for guiding said intermediate support member in said pressing direction on said base member during an operation of said drive section.

16. The device for applying an adhesive tape according to claim 14, wherein said holding mechanism further includes an intermediate support member for fixedly supporting said plurality of suction blocks and shiftably held on said base member, and wherein said pressing mechanism further includes a guide member for guiding said intermediate support member in said pressing direction on said base member during an operation of said drive section.

17. The device for applying an adhesive tape according to claim 12, wherein said vacuum source includes a plurality of vacuum generators independent from each other, individually connected to said plurality of negative pressure regions.

18. The device for applying an adhesive tape according to claim 10, wherein said holding surface of said suction member is constituted as a flat surface or a curved surface, substantially free of twist and step as a whole.

19. The device for applying an adhesive tape according to claim 10, further comprising a positioning mechanism for positioning said holding mechanism at a predetermined adhering-preparation position in the objective surface area.

20. The device for applying an adhesive tape as defined by claim 19, wherein said positioning mechanism includes a first engagement member fixedly held on said base member, a second engagement member movably held on said base member, and a drive element for moving said second engagement member relative to said base member; said first and second engagement members being fixedly engaged with an article having the objective surface area, under a driving operation of said drive element, to locate said suction member to said adhering-preparation position.

21. The device for applying an adhesive tape according to claim 11, further comprising a positioning mechanism for positioning said holding mechanism at a predetermined adhering-preparation position in the objective surface area.

22. The device for applying an adhesive tape as defined by claim 21, wherein said positioning mechanism includes a first engagement member fixedly held on said base member, a second engagement member movably held on said base member, and a drive element for moving said second engagement member relative to said base member; said first and second engagement members being fixedly engaged with an article having the objective surface area, under a driving operation of said drive element, to locate said suction member to said adhering-preparation position.

23. The device for applying an adhesive tape according to claim 12, further comprising a positioning mechanism for positioning said holding mechanism at a predetermined adhering-preparation position in the objective surface area.

24. The device for applying an adhesive tape as defined by claim 23, wherein said positioning mechanism includes a first engagement member fixedly held on said base member, a second engagement member movably held on said base member, and a drive element for moving said second engagement member relative to said base member; said first and second engagement members being fixedly engaged with an article having the objective surface area, under a driving operation of said drive element, to locate said suction member to said adhering-preparation position.

25. The device for applying an adhesive tape according to claim 13, further comprising a positioning mechanism for positioning said holding mechanism at a predetermined adhering-preparation position in the objective surface area.

26. The device for applying an adhesive tape as defined by claim 25, wherein said positioning mechanism includes a first engagement member fixedly held on said base member, a second engagement member movably held on said base member, and a drive element for moving said second engagement member relative to said base member; said first and second engagement members being fixedly engaged with an article having the objective surface area, under a driving operation of said drive element, to locate said suction member to said adhering-preparation position.

27. The device for applying an adhesive tape according to claim 14, further comprising a positioning mechanism for positioning said holding mechanism at a predetermined adhering-preparation position in the objective surface area.

28. The device for applying an adhesive tape as defined by claim 27, wherein said positioning mechanism includes a first engagement member fixedly held on said base member, a second engagement member movably held on said base member, and a drive element for moving said second engagement member relative to said base member; said first and second engagement members being fixedly engaged with an article having the objective surface area, under a driving operation of said drive element, to locate said suction member to said adhering-preparation position.

29. The device for applying an adhesive tape according to claim 18, further comprising a positioning mechanism for positioning said holding mechanism at a predetermined adhering-preparation position in the objective surface area, wherein said positioning mechanism includes a first engagement member fixedly held on said base member, a second engagement member movably held on said base member, and a drive element for moving said second engagement member relative to said base member; said first and second engagement members being fixedly engaged with an article having the objective surface area, under a driving operation of said drive element, to locate said suction member to said adhering-preparation position.
